(19) United States
(12) Patent Application Publication
(10) Pub. No.: US 2026/0005481 A1
(43) Pub. Date: Jan. 1, 2026

(54) TRAVEL ADAPTOR

(71) Applicant: Huizhou Ouli Technology Co., Ltd., Huizhou (CN)

(72) Inventor: Song Liu, Huizhou (CN)

(21) Appl. No.: 19/031,241

(22) Filed: Jan. 17, 2025

(30) Foreign Application Priority Data
Jul. 1, 2024 (CN) 202421542236.3

(51) Int. Cl. H01R 31/06; H01R 13/52

(52) U.S. Cl. CPC H01R 31/065; H01R 13/5205

(57) ABSTRACT

A travel adaptor includes a first housing, a second housing and an extension wire, wherein the first housing is provided with a first conductive terminal and a plurality of pins of different specifications, and the pins are slidably mounted on the first housing and used for contacting the first conductive tenninal; the second housing is provided with a second conductive terminal and a plurality of jacks of different specifications, wherein the jacks are used for plugging an external electrical access device into the second housing and contacting the second conductive terminal; the extension wire is electrically connected to the first conductive terminal and the second conductive terminal; by providing the first housing and the second housing with pins and jacks of different specifications, respectively, it is possible to adapt to a greater variety of plugs and sockets.

### CROSS-REFERENCE TO RELATED APPLICATIONS

This application claims priority to Chinese Patent Application No. 202421542236.3, filed on July 1, 2024, the content of which is incorporated herein by reference in its entirety.

### TECHNICAL FIELD

The application relates to the technical field of adaptors, and more particularly to a travel adaptor.

### BACKGROUND

With the popularity of modern electronic devices, people often need to use a variety of electronic devices, such as cell phones, tablets, notebook computers, etc. while traveling or working. These devices typically require access to a power source for charging or direct power. Travel adaptors have become an essential accessory in order to meet the power standards of different devices and different countries.

Existing travel adaptor designs typically integrate multiple output ports on one housing while the input ports are also located on the same housing. While this design is somewhat user friendly, it also has some limitations:

Space limitations: since both the input ports and the output ports are integrated on the same housing, the user must place the powered device near the adaptor during use, which limits the placement and use flexibility of the device.

Power supply line length limitations: when the power supply line length of the powered device is insufficient to extend from the device location to the adaptor, the user will not be able to use the device properly, which is particularly inconvenient where space is limited or the power supply socket location is fixed.

### SUMMARY

The technical problem to be solved by the application is: a travel adaptor is provided to address the space and power supply line length limitations of travel adaptors during use in prior art.

In order to solve the above-mentioned technical problem, the technical solution adopted by the application is: a travel adaptor including

a first housing provided with a first conductive terminal and a plurality of pins of different specifications, wherein the pins are slidably mounted on the first housing and used for contacting the first conductive terminal;

a second housing provided with a second conductive terminal and a plurality of jacks of different specifications, wherein the jacks are used for plugging an external electrical access device into the second housing and contacting the second conductive terminal;

an extension wire electrically connecting the first conductive terminal and the second conductive terminal.

Further, a side wall of the first housing is provided with a first mounting hole communicating with the inside thereof, and the extension wire is mounted to the first mounting hole.

Further, a first sealing sleeve is provided within the first mounting hole, and the first sealing sleeve is sleeved on the extension wire.

Further, a material of the first sealing sleeve is a rubber material.

Further, a side wall of the second housing is provided with a second mounting hole communicating with the inside thereof, and the extension wire is mounted to the second mounting hole.

Further, a second sealing sleeve is provided within the second mounting hole, and the second sealing sleeve is sleeved on the extension wire.

Further, a material of the second sealing sleeve is a rubber material.

Further, a first positioning groove is provided within the first housing and a first positioning projection is provided on the extension wire, and the first positioning projection is inserted into the first positioning groove.

Further, a second positioning groove is provided within the second housing and a second positioning projection is provided on the extension wire, and the second positioning projection is inserted into the second positioning groove.

Further, a winding clamp for clamping the extension wire is also included.

The beneficial effects of the application are: by providing the first housing and the second housing with pins and jacks of different specifications, respectively, it is possible to adapt to a greater variety of plugs and sockets, thereby improving the adaptability to different national and regional power supply standards. The user can freely adjust the relative position of the first housing and the second housing according to the specific position of the powered device and the layout of the power supply socket, and is no longer limited by the power supply line length, thereby making space utilization more flexible; since the pin can be slidably mounted to and contact the first conductive terminal, the user can quickly adjust the position of the pin according to the specification of the plug actually used, so as to achieve plug and play, simplifying the operation process and improving the user experience; the extension wires electrically connect the conductive terminals of the two housings, ensuring the stability and safety of power transmission. At the same time, since the input and output ports are physically separated, the risk of overheating in high load use is reduced, and the safety of the product is improved; due to the independent design of the first housing and the second housing, when maintenance or upgrading is required, the user can replace only the corresponding parts without replacing the whole adaptor, which reduces the maintenance cost and facilitates the upgrading and replacing of the product; the second housing is designed with a plurality ofjacks of different specifications to provide power to a plurality of devices at the same time, meeting the user's need to charge or power a plurality of devices at the same time while traveling or working.

### BRIEF DESCRIPTION OF THE DRAWINGS

FIG. 1 is a schematic view showing a structure of a travel adaptor of Example 1 of the application;

FIG. 2 is a schematic view showing a structure of another perspective of the travel adaptor of Example 1 of the application;

FIG. 3 is a schematic view showing an internal structure of a first housing of Example 1 of the application;

FIG. 4 is a schematic view showing an internal structure of another perspective of the first housing of Example 1 of the application; and

FIG. 5 is a schematic view showing the structure of the travel adaptor of Example 1 of the application (in a state where an expansion housing is inserted).

FIG. 6 is a schematic view showing a structure of a travel adaptor of Example 1 of the application(the jack is a EU jack);

FIG. 7 is a schematic view showing a structure of a travel adaptor of Example 1 of the application (the jack is a USA jack);

FIG. 8 is a schematic view showing a structure of a travel adaptor of Example 1 of the application (the jack is a UK jack);

FIG. 9 is a schematic view showing a structure of a travel adaptor of Example 1 of the application (the jack is a Chinese jack).

### Description of reference numerals:

1. first housing; 11. first conductive terminal; 12. first positioning groove; 2. second housing; 21. jack; 22. expansion jack; 3. extension wire; 31. first sealing sleeve; 32. first positioning projection; 4. pin; 41. push handle; 5. expansion housing; 51. Type-c hole; 52. USB hole.

### DETAILED DESCRIPTION OF THE EMBODIMENTS

In order to explain the technical contents, the objects, and the effects of the application in detail, the embodiments will be described below with reference to the accompanying drawings.

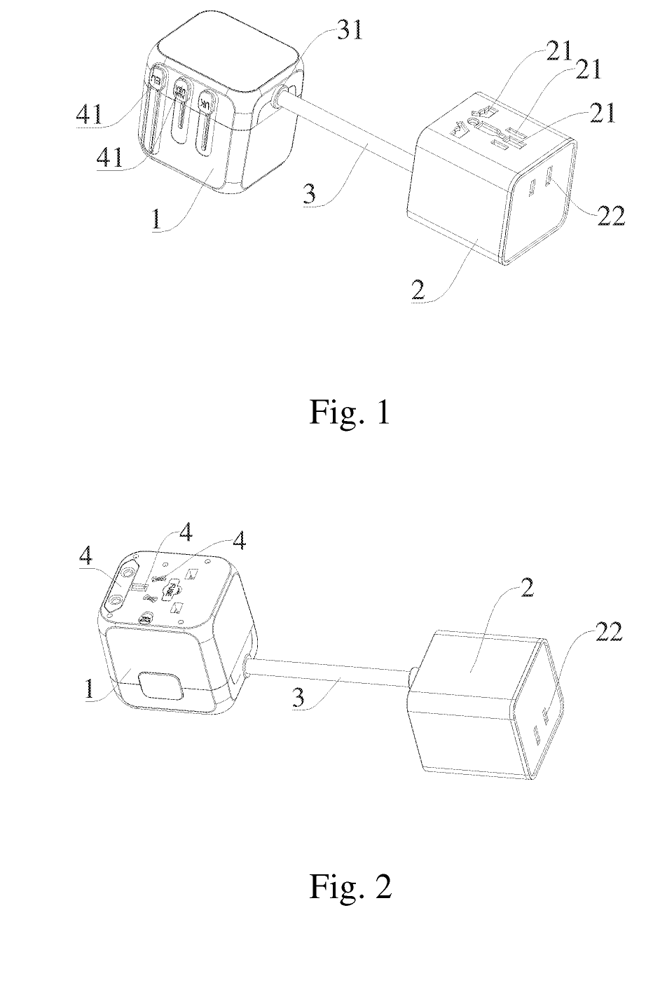

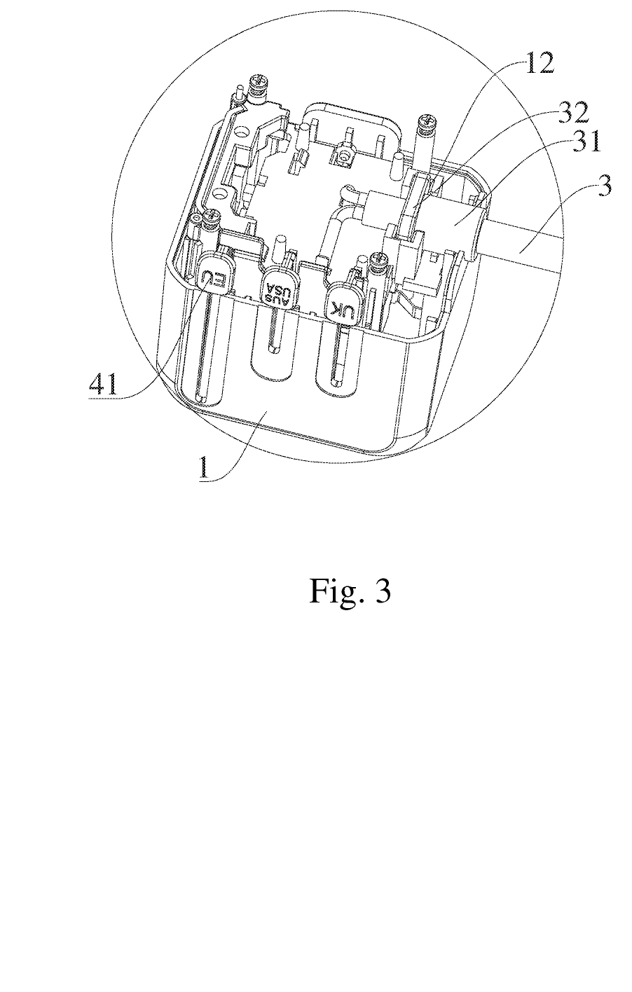

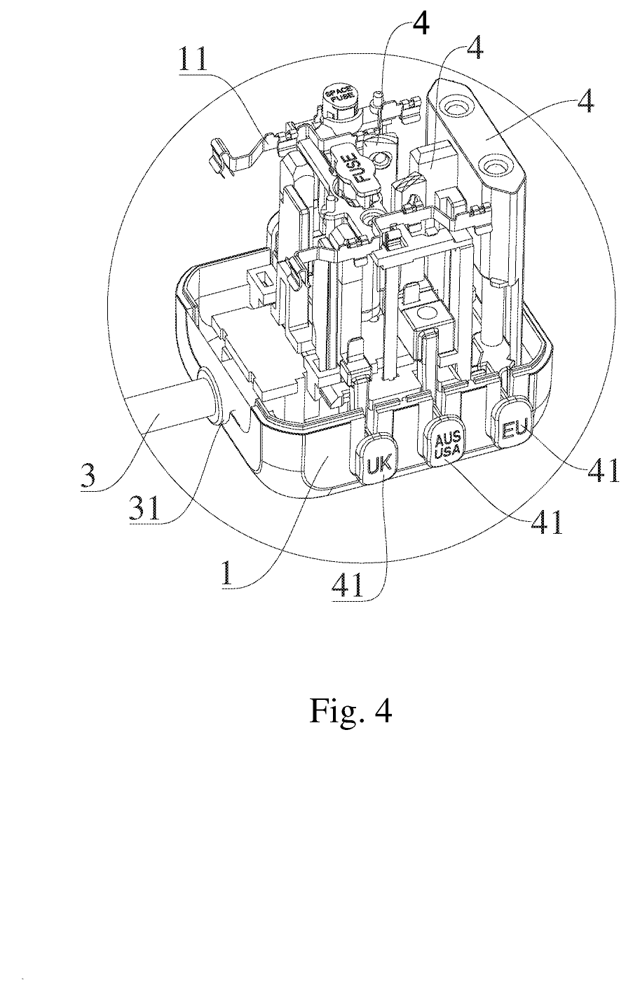

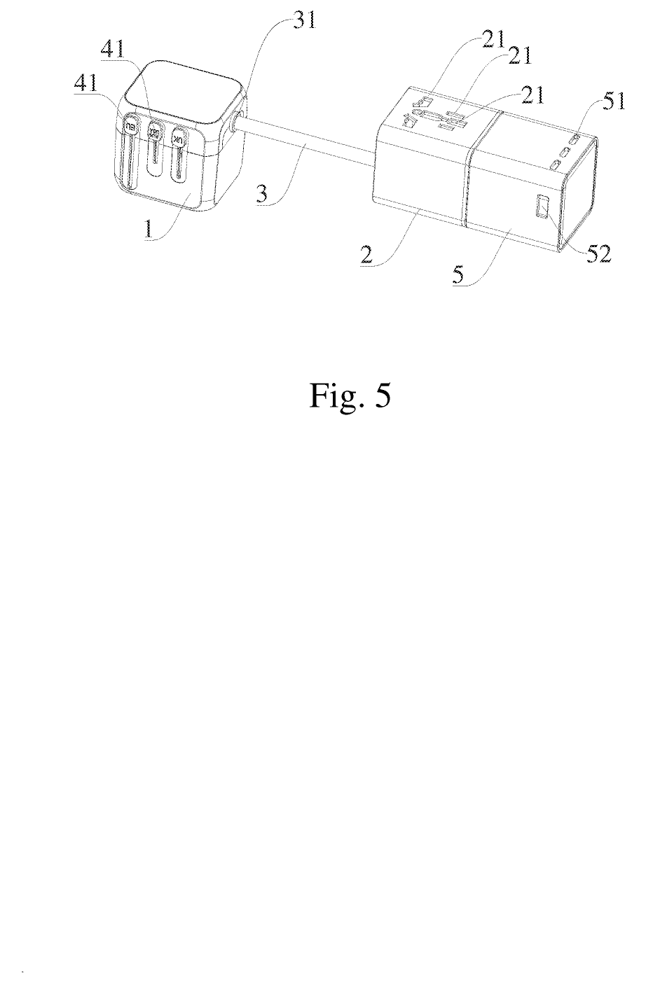

Referring to FIGS. 1 to 5, a travel adaptor includes

a first housing 1 provided with a first conductive terminal 11 and a plurality of pins 4 of different specifications, wherein the pins 4 are slidably mounted on the first housing I and used for contacting the first conductive terminal 11;

a second housing 2 provided with a second conductive terminal and a plurality of jacks 21 of different specifications, wherein the jacks 21 are used for plugging an external electrical access device into the second housing 2 and contacting the second conductive terminal;

an extension wire 3 electrically connecting the first conductive terminal 11 and the second conductive terminal.

As can be seen from the above description, the beneficial effects of the application are as follows: by providing the first housing 1 and the second housing 2 with pins 4 and jacks 21 of different specifications, respectively, it is possible to adapt to a greater variety of plugs and sockets, thereby improving the adaptability to different national and regional power supply standards; the user can freely adjust the relative position of the first housing 1 and the second housing 2 according to the specific position of the powered device and the layout of the power supply socket, and is no longer limited by the power supply line length, thereby making space utilization more flexible; since the pin 4 can be slidably mounted to and contact the first conductive terminal 11, a user can quickly adjust the position of the pin 4 according to the specification of the plug actually used, so as to achieve plug and play, simplifying the operation process and improving the user experience; the extension wires 3 electrically connect the conductive terminals of the two housings, ensuring the stability and safety of power transmission. At the same time, since the input and output ports are physically separated, the risk of overheating in high load use is reduced, and the safety of the product is improved; due to the independent design of the first housing 1 and the second housing 2, when maintenance or upgrading is required, the user can replace only the corresponding parts without replacing the whole adaptor, which reduces the maintenance cost and facilitates the upgrading and replacing of the product; the second housing 2 is designed with a plurality of jacks 21 of different specifications to provide power to a plurality of devices at the same time, meeting the user's need to charge or power a plurality of devices at the same time while traveling or working.

Further, the side wall of the first housing 1 is provided with a first mounting hole communicating with the inside thereof, and the extension wire 3 is mounted to the first mounting hole.

As can be seen from the above description, by providing a first mounting hole in the side wall of the first housing 1 and mounting the extension wire 3 in the hole, it is possible to protect the wire from external damage and ensure stable connection of the wire to the housing.

Further, a first sealing sleeve 31 is provided within the first mounting hole, and the first sealing sleeve 31 is sleeved on the extension wire 3.

As can be seen from the above description, the first sealing sleeve 31 in the first mounting hole not only provides additional wire protection, but also prevents dust and moisture from entering by a sealing function, improving durability and safety of the adaptor.

Further, the material of the first sealing sleeve 31 is a rubber material.

As can be seen from the above description, the use of the rubber material as the first sealing sleeve 31 can protect the wire more effectively due to its good elasticity and sealing performance, and the rubber material also has good insulation performance.

Further, the side wall of the second housing 2 is provided with a second mounting hole communicating with the inside thereof, and the extension wire 3 is mounted in the second mounting hole.

As can be seen from the above description, the second mounting hole of the second housing 2 provides a stable and protective mounting point for the extension wire 3.

Further, a second sealing sleeve is provided within the second mounting hole, and the second sealing sleeve is sleeved on the extension wire 3.

As can be seen from the above description, the second sealing sleeve provides additional protection to the wires and improves the water and dust resistance of the product by a sealing function.

Further, the material of the second sealing sleeve is a rubber material.

As can be seen from the above description, using a rubber material as the second sealing sleeve can protect the wire more effectively due to its good elasticity and sealing performance, and the rubber material also has good insulation performance.

Further, a first positioning groove 12 is provided within the first housing 1, a first positioning projection 32 is provided on the extension wire 3, and the first positioning projection 32 is inserted into the first positioning groove 12.

As can be seen from the above description, the design of the first positioning groove 12 and the first positioning projection 32 ensures accurate connection and fixation of the extension wire 3 to the first housing 1, preventing accidental detachment or displacement of the wire during use.

Further, a second positioning groove is provided within the second housing 2 and a second positioning projection is provided on the extension wire 3, and the second positioning projection is inserted into the second positioning groove.

As can be seen from the above description, the design of the second positioning groove and the second positioning projection ensures accurate connection and fixation of the extension wire 3 to the first housing 1, preventing accidental detachment or displacement of the wire during use.

Further, a winding clamp for clamping the extension wire is included.

As can be seen from the above description, the design of the winding clamp allows the user to conveniently receive and carry the extension wire 3, avoiding the messy wire and improving the portability and cleanliness of the product.

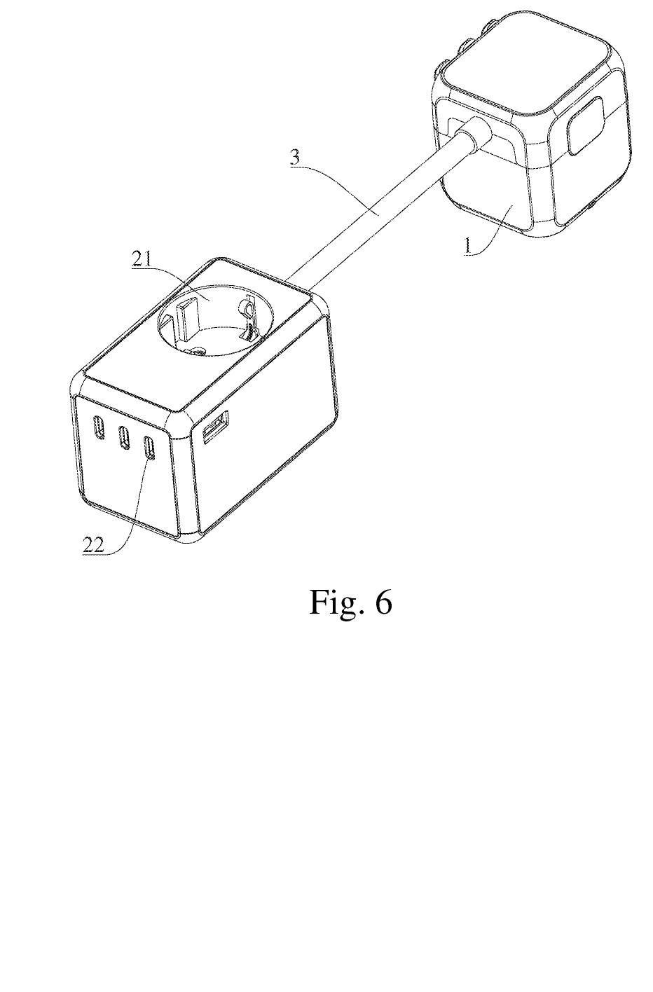

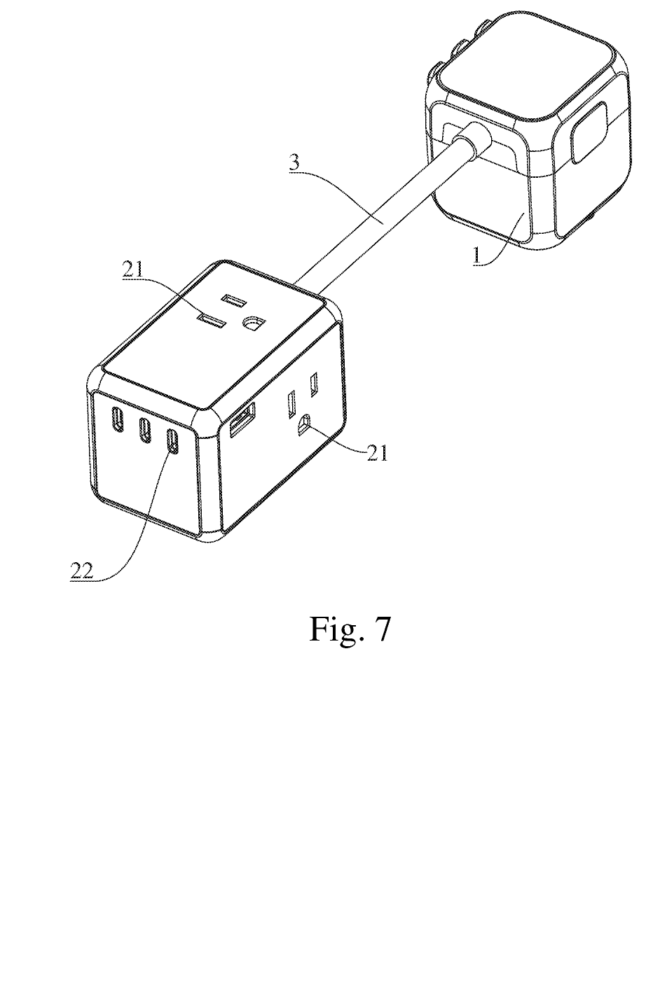

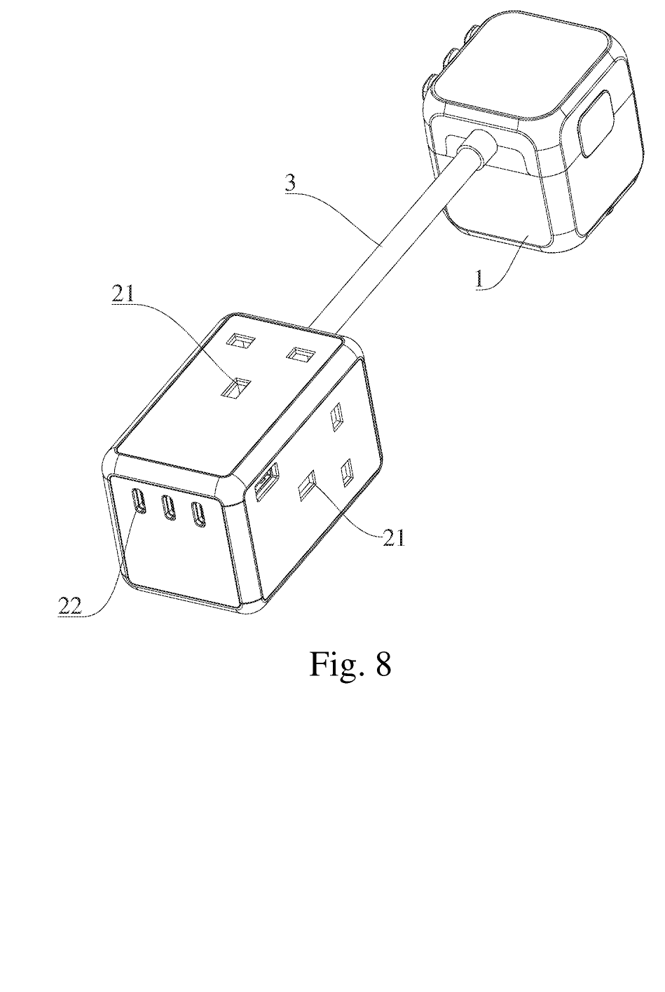

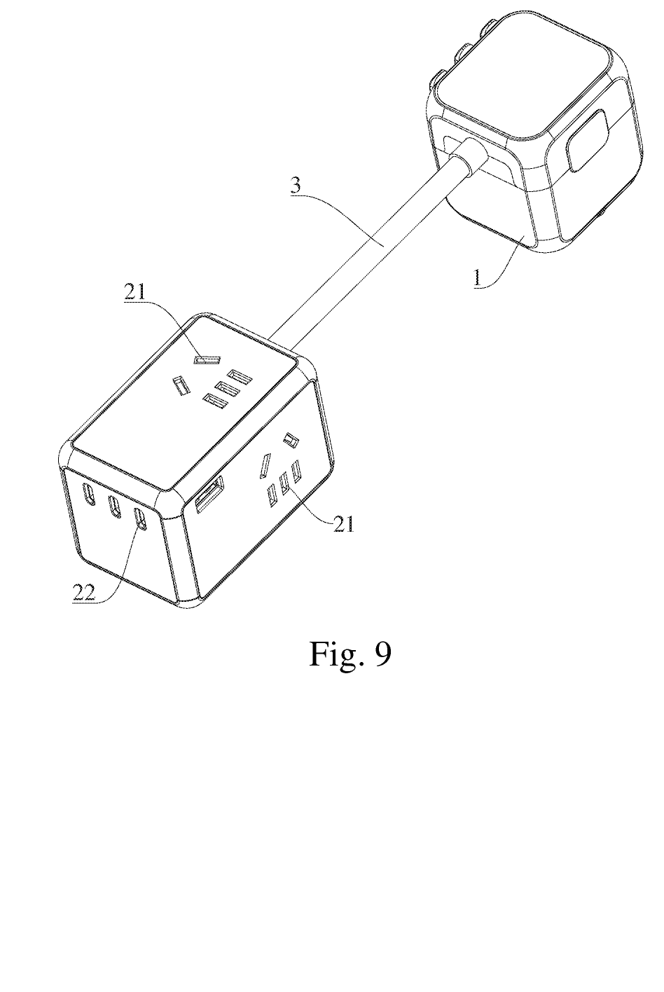

Referring to FIGS. 1 to 5, Example 1 of the application is: a travel adaptor including a first housing 1, a second housing 2 and an extension wire 3, wherein the first housing 1 is provided with a first conductive terminal 11 and a plurality of pins 4 of different specifications, and the pins 4 are slidably mounted on the first housing 1 and are used for contacting the first conductive terminal 11; the second housing 2 is provided with a second conductive terminal (not shown) and a plurality of jacks 21 of different specifications, wherein the jacks 21 are used for plugging an external electrical access device into the second housing 2 and contacting the second conductive terminal, and the specifications of the jacks 21 can be one or more, and as an option, the specifications of the jacks 21 include at least one of a UK jack (as shown in FIG. 8), a European jack (as shown in FIG. 6), a USA jack(as shown in FIG. 7), a Chinese jack (as shown in FIG. 9), an Indian jack and an Australian jack; the extension wire 3 is electrically connected to the first conductive terminal 11 and the second conductive terminal; it will be readily appreciated that by providing the first housing 1 and the second housing 2 with pins 4 and jacks 21 of a variety of different specifications, respectively, it is possible to adapt to a wider variety of plugs and sockets, improving the adaptability to different national and regional power standards. The user can freely adjust the relative position of the first housing 1 and the second housing 2 according to the specific position of the powered device and the layout of the power supply socket, and is no longer limited by the power supply line length, thereby making space utilization more flexible; since the pin 4 can be slidably mounted to and contact the first conductive terminal 11, a user can quickly adjust the position of the pin 4 according to the specification of the plug actually used, so as to achieve plug and play, simplifying the operation process and improving the user experience; the extension wires 3 electrically connect the conductive terminals of the two housings, ensuring the stability and safety of the electric energy transmission. At the same time, since the input and output ports are physically separated, the risk of overheating in high load use is reduced, and the safety of the product is improved; due to the independent design of the first housing 1 and the second housing 2, when maintenance or upgrading is required, the user can replace only the corresponding parts without replacing the whole adaptor, which reduces the maintenance cost and facilitates the upgrading and replacing of the product; the second housing 2 is designed with a plurality of jacks 21 of different specifications to provide power to a plurality of devices at the same time, meeting the user's need to charge or power a plurality of devices at the same time while traveling or working.

Specifically, the specification of the pin 4 includes but is not limited to a USA pin, a European pin, a UK pin or an Australian pin, etc. and the pin 4 of each specification is provided with a push handle 41 which is slidably mounted outside the first housing 1 for a user to push the pin 4.

Preferably, the side wall of the first housing 1 is provided with a first mounting hole communicating with the inside thereof, the extension wire 3 is mounted in the first mounting hole, and by providing a first mounting hole in the side wall of the first housing 1 and mounting the extension wire 3 in the hole, it is possible to protect the wire from external damage and ensure stable connection of the wire to the housing; specifically, a first sealing sleeve 31 is provided within the first mounting hole, and the first sealing sleeve 31 is sleeved on the extension wire 3; the first sealing sleeve 31 in the first mounting hole not only provides additional wire protection, but also prevents the ingress of dust and moisture through a sealing function, improving the durability and safety of the adaptor; more specifically, the side wall of the second housing 2 is provided with a second mounting hole communicating with the inside thereof, the extension wire 3 is mounted in the second mounting hole, and the second mounting hole of the second housing 2 provides a stable and protective mounting point for the extension wire 3; a second sealing sleeve is provided within the second mounting hole, the second sealing sleeve is sleeved on the extension wire 3, and the second sealing sleeve provides additional protection to the wire and improves the water and dust resistance of the product by a sealing function; specifically, in the example, the material of the first sealing sleeve 31 and the material of the second sealing sleeve are rubber materials.

Preferably, a first positioning groove 12 is provided within the first housing 1, a first positioning projection 32 is provided on the extension wire 3, the first positioning projection 32 is inserted into the first positioning groove 12, and the design of the first positioning groove 12 and the first positioning projection 32 ensures the accurate connection and fixation of the extension wire 3 and the first housing 1, preventing accidental detachment or displacement of the wire during use; further, a second positioning groove is provided within the second housing 2, a second positioning projection is provided on the extension wire 3, the second positioning projection is inserted into the second positioning groove, and the design of the second positioning groove and the second positioning projection ensures the accurate connection and fixation of the extension wire 3 with the first housing 1, preventing accidental detachment or displacement of the wire during use.

As an alternative, a winding clamp for clamping the extension wire can also be provided, and the design of the winding clamp allows a user to conveniently receive and carry the extension wire 3, avoiding the messy wire and improving the portability and cleanliness of the product; the winding clamps include, but are not limited to, magic tape strips, clips, and the like.

In the example, an expansion housing 5 is also included, wherein the expansion housing 5 is provided with a Type-c hole 51 and a USB hole 52; the second housing 2 is provided with an expansion jack 22, and the expansion housing 5 is plugged into the expansion jack so as to achieve the electrical connection between the Type-c hole 51 and the USB hole 52 and the second conductive terminal; in this way, a user can choose to plug the expansion housing 5 into the expansion jack 22 of the second housing 2 according to actual application requirements during use, so as to achieve the expansion of the jack mode and improve the applicability of the travel adaptor; the specification of the expansion jack 22 may be one or more, and the specification of the expansion jack 22 includes at least one of a UK jack, a European jack, a USA jack, an Indian jack and an Australian jack.

In view of the above, the travel adaptor provided by the application is able to adapt to a greater variety of plugs and sockets by providing the first housing and the second housing with pins and jacks of different specifications, respectively, thereby improving the adaptability to different national and regional power supply standards. The user can freely adjust the relative position of the first housing and the second housing according to the specific position of the powered device and the layout of the power supply socket, and is no longer limited by the power supply line length, thereby making space utilization more flexible; since the pin can be slidably mounted to and contact the first conductive terminal, the user can quickly adjust the position of the pin according to the specification of the plug actually used, so as to achieve plug and play, simplifying the operation process and improving the user experience; the extension wires electrically connect the conductive terminals of the two housings, ensuring the stability and safety of power transmission. At the same time, since the input and output ports are physically separated, the risk of overheating in high load use is reduced, and the safety of the product is improved; due to the independent design of the first housing and the second housing, when maintenance or upgrading is required, the user can replace only the corresponding parts without replacing the whole adaptor, which reduces the maintenance cost and facilitates the upgrading and replacing of the product; the second housing is designed with a plurality of jacks of different specifications to provide power to a plurality of devices at the same time, meeting the user's need to charge or power a plurality of devices at the same time while traveling or working.

The above-mentioned description is only an example of the application, and is not intended to limit the scope of the application, and all equivalent transformation performed by using the contents of the specification and the drawings of the application or directly or indirectly applied to the related technical fields are included in the scope of the application.

1. A travel adaptor, comprising:
a first housing provided with a first conductive terminal and a plurality of pins of different specifications, wherein the pins are slidably mounted on the first housing and used for contacting the first conductive terminal;
a second housing provided with a second conductive terminal and a plurality of jacks of different specifications, wherein the jacks are used for plugging an external electrical access device into the second housing and contacting the second conductive terminal; and an extension wire electrically connecting the first conductive terminal and the second conductive terminal.

2. The travel adaptor of claim 1, wherein a side wall of the first housing is provided with a first mounting hole communicating with the inside thereof, and the extension wire is mounted to the first mounting hole.

3. The travel adaptor of claim 2, wherein a first sealing sleeve is provided within the first mounting hole, the first sealing sleeve is sleeved on the extension wire.

4. The travel adaptor of claim 3, wherein a material of the first sealing sleeve is rubber material.

5. The travel adaptor of claim 1, wherein a side wall of the second housing is provided with a second mounting hole communicating with the inside thereof, and the extension wire is mounted to the second mounting hole.

6. The travel adaptor of claim 5, wherein a second sealing sleeve is provided within the second mounting hole, the second sealing sleeve is sleeved on the extension wire.

7. The travel adaptor of claim 6, wherein a material of the second sealing sleeve is rubber material.

8. The travel adaptor of claim 1, wherein a first positioning groove is provided within the first housing and a first positioning projection is provided on the extension wire, and the first positioning projection is inserted into the first positioning groove.

9. The travel adaptor of claim 1, wherein a second positioning groove is provided within the second housing and a second positioning projection is provided on the extension wire, and the second positioning projection is inserted into the second positioning groove.

10. The travel adaptor of claim 1 further comprising a winding clamp for clamping the extension wire.
